(19) United States
(12) Patent Application Publication
(10) Pub. No.: US 2026/0303568 A1
(43) Pub. Date: Oct. 1, 2026

(54) MEDIA AGENT FIREWALL FOR ARTIFICIAL INTELLIGENCE (AI)-GENERATED MEDIA EDITING COMMANDS

(71) Applicant: Dorian Cartwright, San Jose, CA (US)

(72) Inventor: Dorian Cartwright, San Jose, CA (US)

(21) Appl. No.: 19/696,215

(22) Filed: Jun. 2, 2026

(51) Int. Cl. H04L 9/40

(52) U.S. Cl. CPC H04L 63/0245

(57) ABSTRACT

A media agent firewall intercepts artificial intelligence-generated media editing commands before execution by a media editing tool. The firewall normalizes a command into a command package identifying a command type, target media asset, target timeline region, requested transformation, source prompt, and associated model or tool identifier. The command package is evaluated against one or more policies, including user authorization, asset permission, likeness, voice, music licensing, brand, destructive-edit, privacy, export, and provenance policies. Based on the evaluation, the firewall permits, blocks, modifies, sandboxes, routes for approval, substitutes an asset, watermarks, or logs the command. In some embodiments, elevated-risk commands are executed in a sandbox project branch before mutation of a primary media project. The system thereby provides rights-aware, policy-controlled, and provenance-recorded execution of AI-generated media edits across conversational assistant and media editing environments.

### FIELD OF THE INVENTION

The present disclosure relates generally to computers and artificial intelligence, and more specifically, to a media agent firewall that intercepts, validates, modifies, sandboxes, permits, blocks, or logs AI-generated media editing commands before such commands are executed by a media editing tool or media generation system.

### BACKGROUND

AI assistants increasingly interact with software tools on behalf of users. In media editing environments, an AI assistant may generate commands that trim a clip, replace a background, add music, modify a person's likeness, change a voice, insert an asset, apply a filter, modify captions, export a file, or publish a result. Such commands may be generated from natural language prompts, automated edit plans, multimodal inputs, user reactions, templates, or inferred preferences.

However, allowing an AI assistant to directly mutate media assets creates technical and legal risks. A command may delete or overwrite source media. A command may modify a person's likeness without authorization. A command may insert unlicensed music, remove required attribution, violate brand rules, exceed platform duration constraints, expose private content, or export a project in violation of user or enterprise policy. A command may be inconsistent with the user's intent, may be generated by an unauthorized session, or may be based on hallucinated rights or assets.

Conventional media editors provide manual undo, user permissions, and project-level access controls. These protections are not sufficient for agentic media workflows in which an AI assistant generates sequences of tool commands, sometimes without the user understanding every underlying operation.

Therefore, a robust technical enforcement layer is needed between an AI assistant and the media editor to validate AI-generated edit commands before execution.

### SUMMARY

The present disclosure addresses these shortcomings with systems, methods, and computer program products for a media agent firewall that provides a technical enforcement layer between an AI assistant and a media editing tool to validate AI-generated media editing commands before execution.

In one embodiment, a media agent firewall intercepts an AI-generated media editing command before execution by a media editing tool. The firewall evaluates the command against one or more policies, including user authorization policy, asset permission policy, likeness policy, voice policy, music licensing policy, brand policy, project scope policy, destructive edit policy, privacy policy, export policy, provenance policy, or platform policy.

The firewall may permit the command, modify the command, require user confirmation, route the command to a sandbox preview environment, block the command, quarantine the command, request additional rights information, substitute a compliant asset, generate a warning, or record an audit log. The firewall may operate locally, remotely, inside a media editing application, inside an operating system, inside a browser extension, inside an AI assistant platform, inside a cloud editing service, or as a gateway between an AI assistant and an editing tool API.

In some embodiments, the firewall normalizes AI-generated media commands into a command representation. The command representation may identify command type, target asset, target layer, target time range, target person, target voice, target brand element, requested transformation, parameter values, source prompt, model identifier, confidence score, and intended export target.

In some embodiments, the firewall generates a risk score for the command. The risk score may be based on whether the command is destructive, whether it modifies protected content, whether it inserts third-party assets, whether it affects a likeness or voice, whether it changes legal disclaimers or required captions, whether it exports externally, whether it publishes to a platform, whether it violates duration or branding constraints, or whether it lacks provenance.

In some embodiments, the firewall provides sandbox execution. A command may be executed on a project copy, temporary branch, preview render, proxy asset, low-resolution version, or isolated container before being applied to the primary project. The user or policy engine may approve the sandboxed result before committing it to the project.

Many other variations are possible.

### BRIEF DESCRIPTION OF FIGURES

The present disclosure will be understood more fully from the detailed description given below and from the accompanying drawings of various embodiments of the disclosure.

FIG. 1 illustrates a media agent firewall positioned between a conversational AI assistant and a media editing tool, according to an embodiment.

FIG. 2 illustrates an AI-generated media editing command package including command type, target asset, target timeline region, source prompt, model identifier, and parameter values, according to an embodiment.

FIG. 3 illustrates a policy evaluation engine for validating commands against permissions, rights, brand rules, destructive edit rules, export rules, and provenance requirements, according to an embodiment.

FIG. 4 illustrates a sandbox preview workflow in which an AI-generated command is executed in an isolated preview branch before commitment, according to an embodiment.

FIG. 5 illustrates command modification or substitution based on a policy violation, according to an embodiment.

FIG. 6 illustrates a rights and likeness clearance gate for media commands involving persons, voices, music, images, brands, or licensed assets, according to an embodiment.

FIG. 7 illustrates an audit log and provenance record generated by the media agent firewall, according to an embodiment.

FIG. 8 illustrates a computing environment for implementing the media agent firewall, according to an embodiment.

FIG. 9 illustrates a method for validating an AI-generated media editing command before execution by a media editing tool, according to an embodiment.

FIG. 10 illustrates a method for rights-aware command substitution or transformation modification based on a policy violation, according to an embodiment.

FIG. 11 illustrates a method for sandbox preview before mutation of a primary media project, according to an embodiment.

FIG. 12 illustrates a method for rights and likeness clearance of AI-generated media editing commands involving persons, voices, music, images, brands, or licensed assets, according to an embodiment.

FIG. 13 illustrates a method for generating an audit log and provenance record for AI-generated media editing commands, according to an embodiment.

### DETAILED DESCRIPTION

The following description provides systems, methods, and computer program products for a media agent firewall that validates AI-generated media editing commands before execution by a media editing tool. The described embodiments are illustrative and not limiting. Features described with respect to one embodiment may be combined with features of other embodiments unless context indicates otherwise. Like reference numerals may refer to like or functionally related elements throughout the drawings.

### I. Systems for Firewall Placement and Command Interception

A media agent firewall may be implemented as software, firmware, middleware, an application programming interface gateway, a browser extension, an operating-system service, an editor plug-in, a cloud service, a local application module, a media editing tool module, an artificial intelligence assistant module, or a distributed system. The media agent firewall may be positioned between an artificial intelligence assistant and one or more media editing tools, media generation systems, rendering services, publishing services, or media editing APIs.

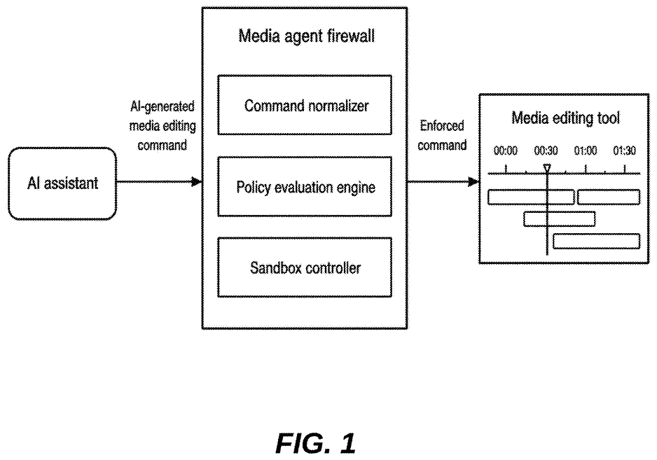

FIG. 1 illustrates a media agent firewall positioned between an artificial intelligence assistant and a media editing tool. In the illustrated embodiment, an AI-generated media editing command is intercepted before the command reaches the media editing tool. The media agent firewall includes a command normalizer, a policy evaluation engine, and a sandbox controller. The firewall outputs an enforced command to the media editing tool only after validation, modification, sandboxing, approval, logging, or another enforcement action has been determined.

The artificial intelligence assistant may be a conversational assistant, multimodal assistant, agentic editing planner, autonomous creative agent, voice assistant, embedded editor assistant, operating-system assistant, browser-based assistant, cloud assistant, or assistant integrated into a media editing application. The media editing tool may include a video editor, image editor, audio editor, captioning tool, rendering service, generative media model, effects engine, social publishing tool, asset library, collaboration workspace, content management system, avatar tool, virtual production tool, augmented reality tool, virtual reality tool, or generative media platform.

In some embodiments, the media tool comprises a social media publishing tool, short-form video platform interface, creator-platform upload interface, advertising-platform upload interface, livestream publishing interface, or other external distribution endpoint. Accordingly, the media agent firewall may intercept not only commands that mutate a local editing timeline, but also AI-generated commands that export, upload, publish, schedule, caption, tag, monetize, boost, watermark, remove a watermark from, or otherwise distribute media to a platform such as a short-form video service, social network, creator marketplace, advertising platform, or enterprise content channel. The firewall may evaluate such commands against platform rules, music and likeness rights, account authority, geographic restrictions, brand rules, privacy rules, monetization rules, age or audience restrictions, required attribution, metadata requirements, watermark requirements, and provenance-manifest requirements before allowing the command to reach the external platform or publishing API.

In some embodiments, the media editing tool is external to the artificial intelligence assistant and is accessed through an application programming interface, plug-in interface, automation interface, operating-system automation layer, browser extension, inter-process communication channel, cloud service endpoint, mobile deep link, local application bridge, or remote procedure call. For example, the artificial intelligence assistant may execute in a first application or cloud assistant environment, while the media editing tool executes as a separate native application, browser-based editor, mobile application, cloud editing service, or third-party creative tool. The media agent firewall may be positioned between the assistant and the external tool so that AI-generated commands are normalized, policy-evaluated, sandboxed, modified, substituted, logged, or blocked before the external tool mutates a project, renders an output, accesses an asset, or publishes media.

Although certain embodiments are described with reference to a video editing application, such as CapCut, the disclosed trust-layer interception architecture is not limited to a particular editing application or media type. In various embodiments, the trust layer may be positioned between an artificial intelligence agent, generative model, editing assistant, automation script, plug-in, or external orchestration service and a conventional creative application, including without limitation a video editing application, image editing application, graphic design application, animation tool, three-dimensional modeling application, audio editing application, presentation design application, game development environment, or mixed-reality content creation tool. The trust layer may intercept proposed edit operations, project-file modifications, timeline operations, layer operations, object insertions, object removals, masking operations, style-transfer operations, color or lighting adjustments, rendering instructions, export commands, or asset substitutions before such operations are committed to a native project state or rendered output. A validator may evaluate the proposed operation based on one or more of project context, user intent, brand policy, copyright or likeness policy, continuity constraints, media-quality constraints, timeline consistency, object persistence, audio-visual synchronization, destructive-edit risk, downstream rendering risk, or user approval requirements. Based on the evaluation, the trust layer may release, block, delay, modify, substitute, sandbox, preview, log, or require confirmation for the proposed operation, thereby allowing artificial intelligence generated creative commands to be treated as provisional operations subject to validation before execution by an existing creative application.

The firewall may intercept commands before they are executed. Intercepted commands may include trim commands, crop commands, caption commands, audio commands, voice synthesis commands, face replacement commands, likeness modification commands, background replacement commands, object insertion commands, style transfer commands, generative fill commands, music insertion commands, render commands, export commands, publish commands, delete commands, overwrite commands, watermark commands, metadata modification commands, and commands that invoke a third-party or platform media service.

### A. Command Normalization and Context Extraction

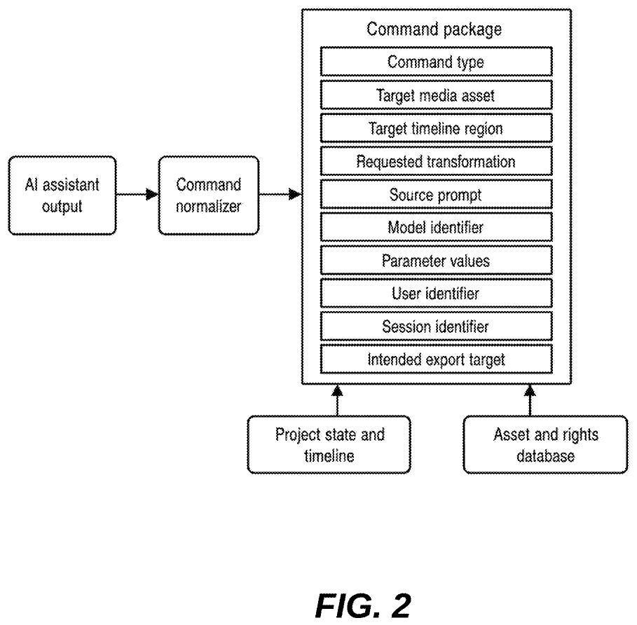

FIG. 2 illustrates conversion of an artificial-intelligence assistant output into a normalized command package. A command normalizer receives an AI assistant output and generates a command package that may identify a command type, target media asset, target timeline region, requested transformation, source prompt, model identifier, parameter values, user identifier, session identifier, and intended export target. The command package may also include a tool identifier, project identifier, target layer, affected person, affected voice, affected brand element, affected legal disclaimer, affected attribution element, confidence value, requested asset source, and expected output type.

The command normalizer may convert diverse AI-generated outputs into a normalized representation usable by downstream policy and enforcement components. For example, a natural language instruction such as “replace the background with a nightclub scene and add trending music” may be converted into a command package identifying a background replacement operation, target frames, target subject mask, generated background prompt, music asset request, licensing requirement, intended output platform, and affected timeline layers.

The firewall may extract context from a project state, timeline, media project file, creative state object, asset library, rights database, user profile, enterprise policy system, brand guideline store, platform policy database, prior edit history, source media repository, model metadata store, collaboration workspace, or publishing service. The extracted context may identify affected project assets, timeline regions, project layers, rights records, output destinations, project states, source prompts, assistant outputs, model identifiers, user permissions, and session permissions.

In some embodiments, the command package preserves the relationship between the AI-generated command and the underlying media project state. This allows the policy evaluation engine, sandbox controller, rights clearance gate, command modification engine, and audit and provenance recorder to evaluate not only the text of the command, but also the assets, timeline regions, persons, voices, brands, licenses, and export targets affected by the command.

### B. Policy Evaluation and Enforcement

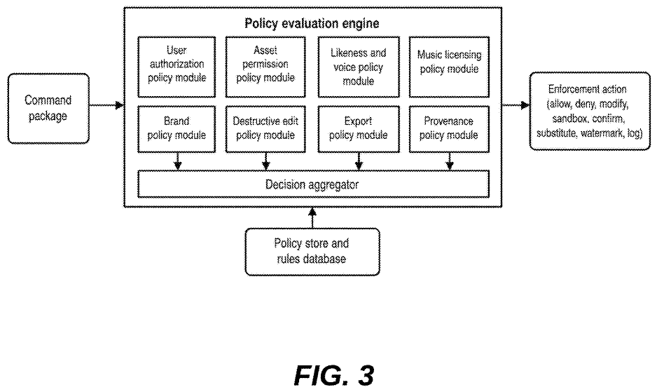

FIG. 3 illustrates a policy evaluation engine that receives a command package and evaluates the command package using multiple policy modules. The policy modules may include a user authorization policy module, asset permission policy module, likeness and voice policy module, music licensing policy module, brand policy module, destructive edit policy module, export policy module, and provenance policy module. A policy store and rules database may supply deterministic rules, user-configured rules, enterprise rules, platform rules, rights-owner rules, jurisdiction-specific rules, project-specific rules, or dynamically generated policy rules.

The user authorization policy may determine whether a user, assistant session, agent identity, organization, workspace role, or collaboration role is permitted to modify a target project, target asset, target layer, target timeline region, person, voice, brand material, legal disclaimer, attribution element, or output destination. An asset permission policy may determine whether the command may use, transform, export, sublicense, publish, combine, crop, remix, or derive from a particular asset. A likeness policy may determine whether a person's face, body, gesture, identity, performance, or visual likeness may be modified, synthesized, imitated, inserted, transformed, or used in a new context. A voice policy may determine whether a voice may be cloned, synthesized, imitated, modified, translated, overdubbed, or associated with new speech.

A music licensing policy may determine whether a sound recording, composition, beat, sample, stem, generated audio asset, or music track may be used for the intended project, output format, territory, duration, platform, audience, monetization status, or publication destination. A brand policy may enforce logo placement, color palette, typography, disclaimers, prohibited claims, legal copy, product representations, tone, competitor restrictions, or campaign-specific rules. A destructive edit policy may prevent deletion, overwriting, flattening, irreversible transformation, source-media replacement, or unauthorized removal of required elements. A privacy policy may prevent exposure of private media, confidential content, faces, metadata, geolocation, minors, medical content, legal content, or enterprise-confidential material.

An export policy may evaluate a target platform, geographic region, resolution, duration, watermark, metadata, rights manifest, publication destination, monetization status, account identity, or distribution channel. A provenance policy may require that model identifiers, prompts, source assets, transformation history, rights metadata, policy references, user approvals, sandbox results, and export conditions be recorded before export or publication.

The policy evaluation engine may generate an enforcement action based on the policy evaluation. Enforcement actions may include allow, block, deny, modify, sandbox, require confirmation, request license, substitute asset, downgrade resolution, add watermark, redact, quarantine, route for human review, escalate to a rights owner or administrator, limit export, add attribution, preserve original media, generate warning, or log only. In some embodiments, a decision aggregator combines outputs of multiple policy modules to generate a single enforcement action. In other embodiments, separate enforcement actions are applied to different portions of a command package.

### C. Sandbox Preview and Branch Commitment

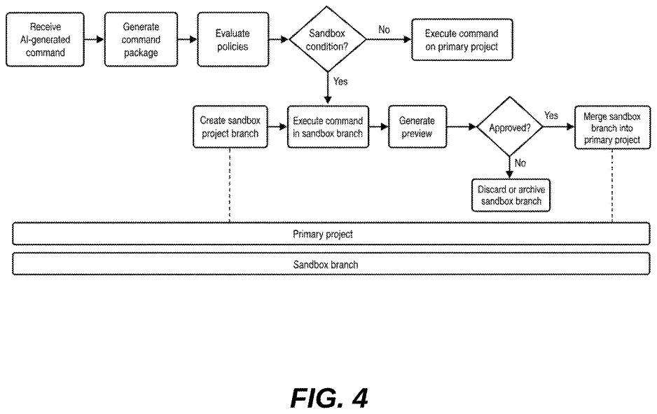

FIG. 4 illustrates a sandbox preview workflow in which an AI-generated command may be evaluated and, when appropriate, executed in an isolated preview branch before commitment to a primary project. A media agent firewall may determine whether a command satisfies a sandbox condition based on risk, policy status, user preference, enterprise policy, destructive edit potential, rights sensitivity, likeness sensitivity, brand sensitivity, export sensitivity, confidence value, or ambiguity in user intent.

The sandbox preview may be a temporary project branch, project copy, proxy render path, isolated container, non-destructive layer, low-resolution render, preview-only output, branch timeline, or staged edit state. If the sandbox condition is not satisfied, the command may be executed on the primary project when otherwise permitted by policy. If the sandbox condition is satisfied, the firewall may create a sandbox project branch and cause the command to be executed in the sandbox project branch instead of directly mutating the primary media project.

The system may generate a sandbox preview and evaluate the preview against policy requirements, rights conditions, user intent criteria, project constraints, quality thresholds, or export requirements. A user, policy engine, rights clearance gate, enterprise administrator, automated approval model, or media editing tool may approve or reject the sandbox preview. If the sandbox result is approved, the sandbox branch may be committed or merged into the primary project. If the sandbox result is rejected, the sandbox branch may be discarded, archived, quarantined, or retained as a rejected candidate for audit or provenance purposes.

The system may maintain parent and sandbox branch metadata. The metadata may identify the original command package, sandbox project branch, primary project state, preview render, approval status, rejection reason, user confirmation, policy clearance, rights clearance, merge status, discard status, or archive status. Maintaining such metadata enables the firewall to support non-destructive review while preserving accountability for AI-generated media editing operations.

### D. Command Modification and Rights-Aware Substitution

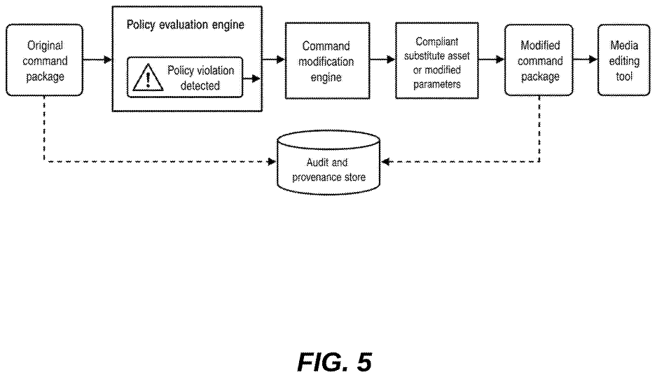

FIG. 5 illustrates command modification or substitution based on a policy violation. In the illustrated embodiment, an original command package is evaluated by a policy evaluation engine, a policy violation is detected, a command modification engine selects a compliant substitute asset or modified parameter set, and a modified command package is provided to the media editing tool. An audit and provenance store may record both the original command package and the modified command package.

The command modification engine may determine that an AI-generated command requires use of a restricted asset, restricted transformation, restricted likeness, restricted voice, restricted music track, restricted image, restricted video segment, restricted brand element, restricted output destination, or restricted publication platform. The policy violation may relate to missing consent, insufficient license scope, platform restriction, geographic restriction, brand-rule violation, missing attribution, prohibited likeness modification, prohibited voice synthesis, destructive edit risk, privacy risk, or export limitation.

The command modification engine may select a compliant substitute asset, compliant transformation, modified parameter set, alternate license source, alternate audio track, alternate visual element, alternate export target, reduced-scope command, watermark condition, attribution condition, or preview-only condition. The substitute or modification may be selected from an approved asset repository, licensed media library, enterprise rights database, user-approved media set, policy-compliant generative model output, platform-approved media source, or brand-approved media repository.

The firewall may update the command package to reference the substitute asset, modified transformation, modified parameter value, alternate timeline region, required watermark, attribution metadata, rights-compliant output condition, or modified export target. The updated command package may be executed directly, routed to a sandbox preview workflow, held for user confirmation, or routed for rights review. The firewall may record the original command package, policy violation, selected substitute or modification, final command package, and enforcement action in an audit log or provenance record.

### E. Rights and Likeness Clearance Gate

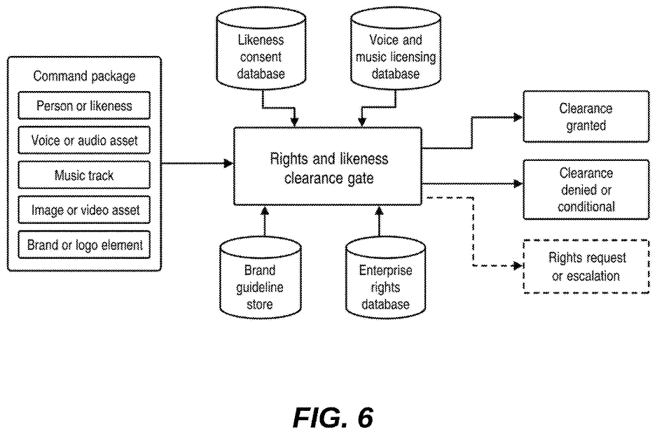

FIG. 6 illustrates a rights and likeness clearance gate for media commands involving persons, voices, music, images, brands, or licensed assets. A command package may identify a protected media element, such as a person or likeness, voice or audio asset, music track, image or video asset, brand or logo element, product representation, licensed clip, or third-party asset. The rights and likeness clearance gate may query one or more clearance sources, including a likeness consent database, voice and music licensing database, brand guideline store, enterprise rights database, asset repository, user permission store, rights-owner system, or platform policy service.

The rights and likeness clearance gate may determine a clearance status for the protected media element. The clearance status may indicate that clearance is granted, denied, conditional, expired, unavailable, territorially limited, platform-limited, duration-limited, monetization-limited, attribution-required, watermark-required, preview-only, or escalation-required. Based on the clearance status, the firewall may allow the command, block the command, request rights information, escalate to a rights owner or administrator, substitute a compliant asset, modify the transformation, add attribution, add a watermark, limit export, require confirmation, or route the command to sandbox preview.

In some embodiments, rights and likeness clearance is performed before policy evaluation. In other embodiments, rights and likeness clearance is performed as part of policy evaluation, after sandbox preview, before export, or immediately before publication. The clearance status may be attached to the command package, project metadata, asset metadata, provenance record, export manifest, or audit log.

The rights and likeness clearance gate may operate across consumer, enterprise, professional, and platform-specific workflows. For example, the clearance gate may prevent an AI assistant from inserting unlicensed music into a monetized social media export, modifying a person's face without consent, cloning a voice for a new script, removing required attribution from a licensed image, using a brand logo contrary to campaign guidelines, or exporting a media project to a platform for which rights have not been cleared.

### F. Audit Logging and Provenance Recording

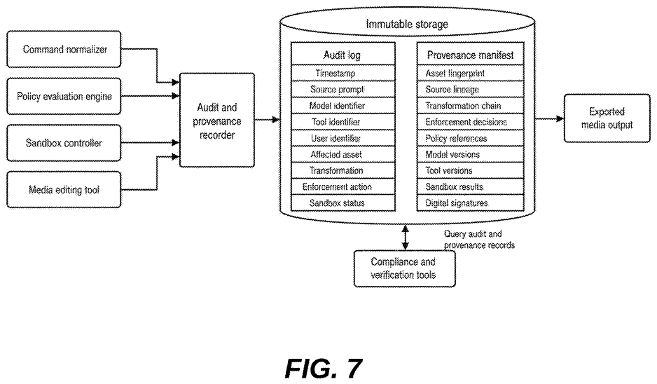

FIG. 7 illustrates an audit log and provenance record generated by the media agent firewall. A command normalizer, policy evaluation engine, sandbox controller, media editing tool, command modification engine, rights clearance gate, or export service may provide command-related data to an audit and provenance recorder. The audit and provenance recorder may store audit log entries and provenance manifests in immutable storage, append-only storage, project metadata, an enterprise compliance repository, a content management system, a media project file, a rights manifest, or a distributed ledger.

The audit log may identify a timestamp, source prompt, assistant output, model identifier, tool identifier, user identifier, session identifier, project identifier, affected asset, affected timeline region, requested transformation, original command package, modified command package, policy evaluation result, sandbox status, clearance status, user approval, and enforcement action. The provenance manifest may identify source assets, asset fingerprints, source lineage, transformation chain, command modifications, substitute assets, sandbox results, model versions, tool versions, policy references, user approvals, rights clearance status, export conditions, digital signatures, and downstream publication targets.

The audit and provenance record may be associated with an exported media output, rendered file, project version, platform publication, rights manifest, or compliance package. A compliance tool, verification tool, user interface, enterprise administrator, rights owner, downstream platform, or audit system may query the audit log or provenance record to verify how an AI-generated media editing command was generated, evaluated, modified, approved, sandboxed, executed, or exported.

In some embodiments, the audit and provenance recorder excludes plaintext sensitive content while preserving identifiers, hashes, fingerprints, references, policy decisions, and verification metadata. In other embodiments, the recorder stores encrypted or access-controlled copies of prompts, assistant outputs, command packages, sandbox previews, or source media references.

### G. Computing Environment

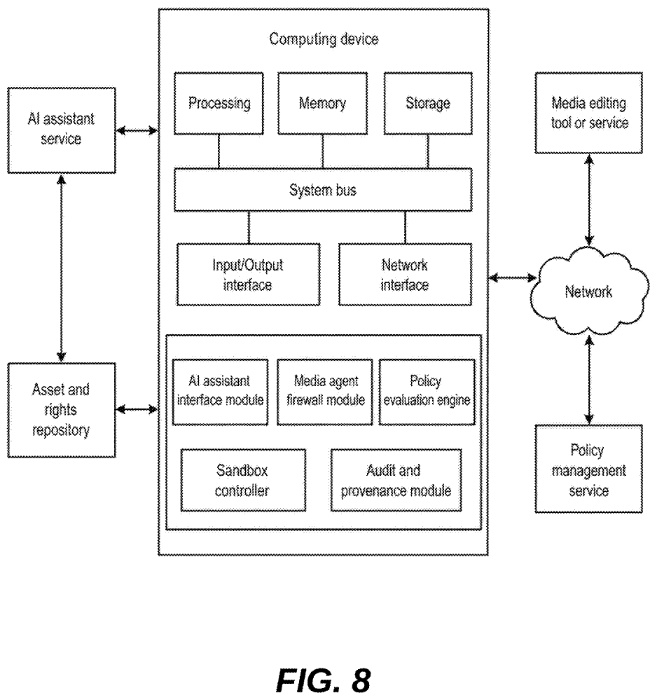

FIG. 8 illustrates a computing environment for implementing the media agent firewall. A computing device may include processing, memory, storage, input/output interfaces, a network interface, and a system bus. The computing device may execute an AI assistant interface module, media agent firewall module, policy evaluation engine, sandbox controller, and audit and provenance module. The computing device may communicate with an AI assistant service, asset and rights repository, media editing tool or service, policy management service, and network.

The disclosed systems may execute on one or more computing devices including mobile devices, client computers, servers, cloud services, browsers, media workstations, edge devices, tablets, smartphones, media production systems, enterprise servers, rendering clusters, or distributed systems. The media agent firewall may operate locally, remotely, inside a media editing application, inside an operating system, inside a browser extension, inside an AI assistant platform, inside a cloud editing service, inside an enterprise gateway, or as a gateway between an AI assistant and an editing tool API.

The media agent firewall may communicate with AI assistant APIs, media editing APIs, model serving APIs, rendering APIs, social publishing APIs, asset repositories, rights databases, likeness consent databases, voice licensing databases, music licensing databases, brand guideline stores, user identity services, policy engines, compliance systems, project repositories, collaboration systems, and publishing services.

The media agent firewall, command normalizer, policy evaluation engine, enforcement controller, sandbox controller, command modification engine, rights and likeness clearance gate, audit and provenance recorder, AI assistant interface, and media editing tool interface may execute on the same device or across multiple devices connected by a network. The components may be implemented as software, firmware, hardware, middleware, microservices, plug-ins, local processes, remote services, policy engines, or combinations thereof.

In some embodiments, one or more components of the media agent firewall operate synchronously before command execution. In other embodiments, one or more components operate asynchronously, such as by generating audit records, requesting rights clearance, evaluating sandbox previews, updating provenance manifests, or notifying compliance systems after an initial enforcement decision. The firewall may apply different enforcement levels based on user identity, project type, enterprise policy, platform destination, rights status, command risk, or output sensitivity.

### II. Methods for Firewall Placement and Command Interception

### A. Firewall Validation of AI-Generated Media Commands

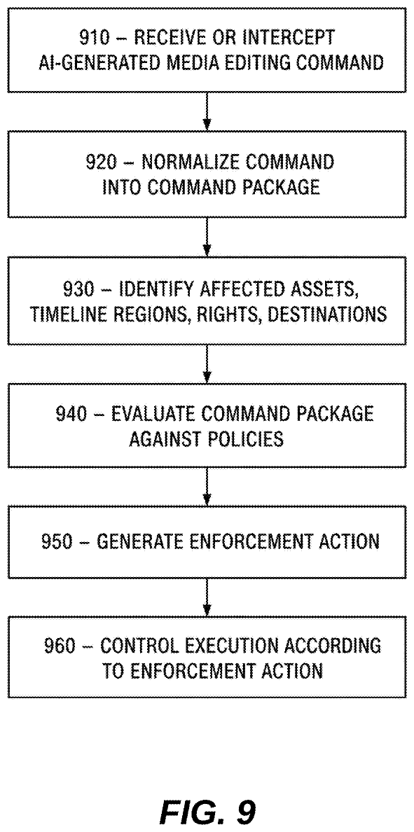

FIG. 9 illustrates a method for validating an AI-generated media editing command before execution by a media editing tool, according to an embodiment.

At step 910, a media agent firewall receives or intercepts an AI-generated media editing command before execution by a media editing tool, media generation system, rendering service, publishing service, or media editing API. The command may be generated by a conversational AI assistant, autonomous creative agent, embedded editor assistant, voice assistant, multimodal assistant, or agentic editing planner.

At step 920, the media agent firewall normalizes the AI-generated media editing command into a command package. The command package may identify a command type, target media asset, target layer, target timeline region, requested transformation, source prompt, model identifier, tool identifier, parameter values, user identifier, session identifier, project identifier, affected person, affected voice, affected brand element, or intended export target.

At step 930, the media agent firewall identifies affected project assets, timeline regions, layers, rights records, output destinations, or project states associated with the command package. The firewall may retrieve context from a project file, creative state object, timeline, asset repository, rights database, user profile, enterprise policy system, brand guide, platform rule database, or prior edit history.

At step 940, the media agent firewall evaluates the command package against one or more policies, including a user authorization policy, asset permission policy, likeness policy, voice policy, music licensing policy, brand policy, destructive edit policy, privacy policy, export policy, provenance policy, or platform policy.

At step 950, the media agent firewall generates an enforcement action based on the policy evaluation. The enforcement action may include allow, block, modify, sandbox, require confirmation, substitute asset, request license, route for human review, watermark, redact, downgrade resolution, quarantine, or log only.

At step 960, the media agent firewall controls execution of the AI-generated media editing command according to the enforcement action. In some embodiments, the command is executed as originally generated, executed after modification, executed only in a sandbox branch, blocked from execution, or held until additional approval, rights information, or policy clearance is obtained.

### B. Rights-Aware Command Substitution

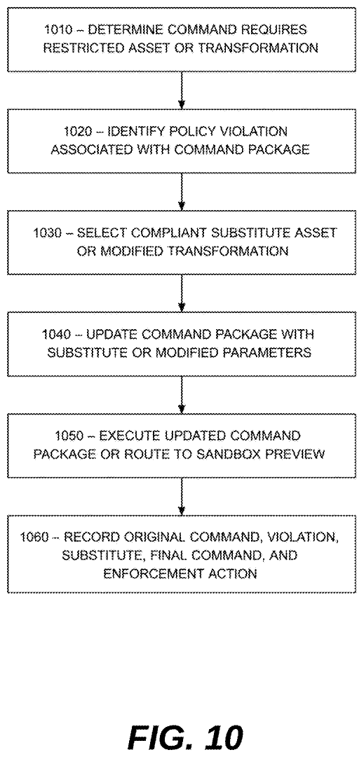

FIG. 10 illustrates a method for rights-aware command substitution or transformation modification based on a policy violation, according to an embodiment.

At step 1010, the media agent firewall determines that an AI-generated media editing command requires use of a restricted asset, restricted transformation, restricted likeness, restricted voice, restricted music track, restricted image, restricted video segment, restricted brand element, or

### Restricted Output Destination.

At step 1020, the media agent firewall identifies a policy violation associated with the command package. The policy violation may relate to missing consent, insufficient license scope, platform restriction, geographic restriction, brand-rule violation, missing attribution, prohibited likeness modification, prohibited voice synthesis, destructive edit risk, or export limitation.

At step 1030, the media agent firewall selects a compliant substitute asset, compliant transformation, modified parameter set, alternate license source, alternate audio track, alternate visual element, alternate export target, or reduced-scope command. The substitute or modification may be selected from an approved asset repository, licensed media library, enterprise rights database, user-approved media set, or policy-compliant generative model output.

At step 1040, the media agent firewall updates the command package to reference the substitute asset, modified transformation, modified parameter value, alternate timeline region, required watermark, attribution metadata, or rights-compliant output condition.

At step 1050, the media agent firewall executes, or permits execution of, the updated command package by the media editing tool. In some embodiments, the updated command package is executed directly; in other embodiments, the updated command package is routed to a sandbox preview workflow before mutation of the primary project.

At step 1060, the media agent firewall records the original command package, identified violation, selected substitute or modification, final command package, and enforcement action in an audit log or provenance record.

### C. Sandbox Preview Before Project Mutation

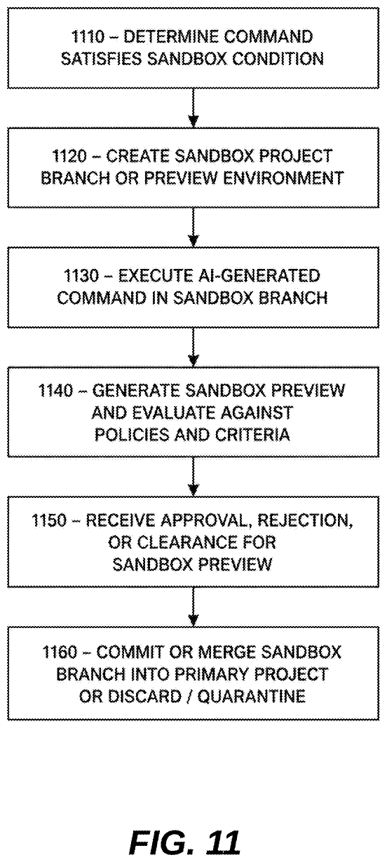

FIG. 11 illustrates a method for sandbox preview before mutation of a primary media project, according to an embodiment.

At step 1110, the media agent firewall determines that an AI-generated media editing command satisfies a sandbox condition. The sandbox condition may be satisfied when the command is destructive, irreversible, rights-sensitive, likeness-sensitive, brand-sensitive, export-sensitive, low-confidence, user-confirmation-sensitive, or otherwise associated with elevated risk.

At step 1120, the media agent firewall creates a sandbox project branch, temporary project copy, proxy render path, isolated container, non-destructive layer, low-resolution preview version, or preview-only output environment.

At step 1130, the media agent firewall causes the AI-generated media editing command to be executed in the sandbox project branch rather than directly mutating the primary media project.

At step 1140, the system generates a sandbox preview and evaluates the sandbox preview against one or more policies, user intent criteria, rights conditions, project constraints, quality thresholds, or export requirements.

At step 1150, the media agent firewall receives approval, rejection, user confirmation, policy clearance, rights clearance, or automated approval for the sandbox preview.

At step 1160, responsive to the approval or clearance, the media agent firewall commits or merges the sandbox project branch into the primary media project. Responsive to rejection or failure to satisfy policy, the media agent firewall discards, archives, quarantines, or retains the sandbox branch as a rejected candidate for audit or provenance purposes.

### D. Rights and Likeness Clearance Gate

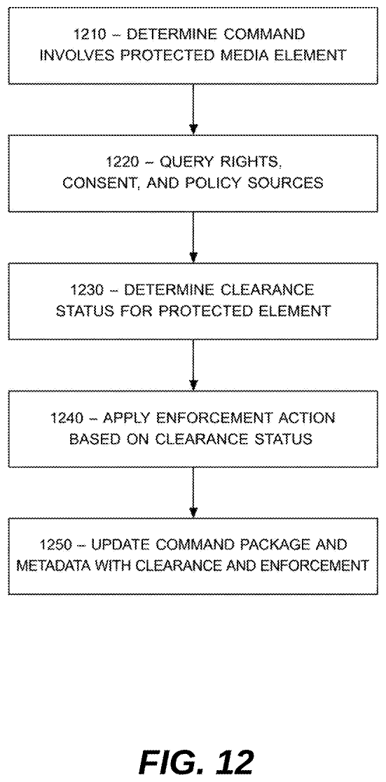

FIG. 12 illustrates a method for rights and likeness clearance of AI-generated media editing commands involving persons, voices, music, images, brands, or licensed assets, according to an embodiment.

At step 1210, the media agent firewall determines that a command package identifies, modifies, synthesizes, imitates, inserts, transforms, exports, or publishes a protected media element. The protected media element may include a person, face, body, gesture, voice, audio asset, music track, image, video asset, brand, logo, product representation, licensed clip, or third-party asset.

At step 1220, the media agent firewall queries one or more rights, consent, or policy sources, including a likeness consent database, voice and music licensing database, enterprise rights database, brand guideline store, asset repository, user permission store, or platform policy service.

At step 1230, the media agent firewall determines a clearance status for the protected media element. The clearance status may indicate that clearance is granted, denied, conditional, expired, unavailable, territorially limited, platform-limited, duration-limited, attribution-required, watermark-required, or escalation-required.

At step 1240, the media agent firewall applies an enforcement action based on the clearance status. The enforcement action may include allowing the command, blocking the command, requesting rights information, escalating to a rights owner or administrator, substituting a compliant asset, modifying the transformation, adding attribution, adding a watermark, limiting export, or requiring user confirmation.

At step 1250, the media agent firewall updates the command package, rights metadata, project metadata, or provenance record to reflect the clearance status and corresponding enforcement action.

### E. Audit Logging and Provenance Record Generation

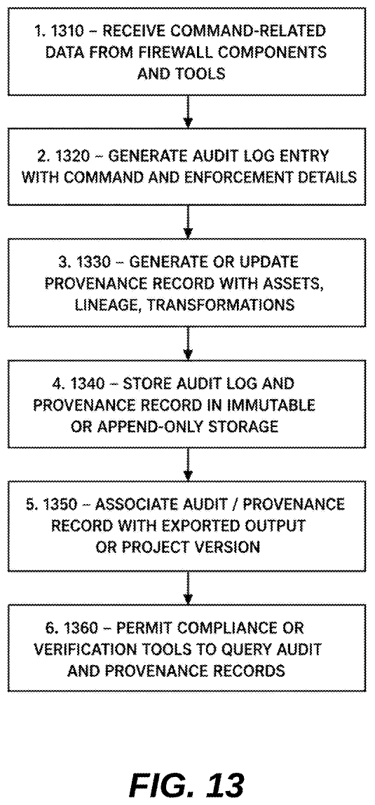

FIG. 13 illustrates a method for generating an audit log and provenance record for AI-generated media editing commands, according to an embodiment.

At step 1310, the media agent firewall receives command-related data from one or more of a command normalizer, policy evaluation engine, sandbox controller, rights clearance gate, command modification engine, media editing tool, or export service.

At step 1320, the media agent firewall generates an audit log entry identifying a timestamp, source prompt, assistant output, model identifier, tool identifier, user identifier, session identifier, project identifier, affected asset, affected timeline region, requested transformation, command package, policy evaluation result, and enforcement action.

At step 1330, the media agent firewall generates or updates a provenance record identifying source assets, asset fingerprints, source lineage, transformation chain, command modifications, substitute assets, sandbox results, model versions, tool versions, policy references, user approvals, rights clearance status, and export conditions.

At step 1340, the media agent firewall stores the audit log entry and provenance record in immutable storage, append-only storage, project metadata, an enterprise compliance repository, a content management system, a media project file, or a distributed ledger.

At step 1350, the media agent firewall associates the audit log entry or provenance record with an exported media output, rendered file, project version, platform publication, rights manifest, or compliance package.

At step 1360, the media agent firewall permits a compliance tool, verification tool, user interface, enterprise administrator, rights owner, or downstream platform to query the audit log or provenance record for verification of the AI-generated media editing workflow.

### III. Generalities

The disclosed firewall may be used for consumer editing tools, enterprise media workflows, social media creation tools, advertising platforms, film and television production tools, training content tools, legal media tools, education tools, collaborative design tools, game development tools, avatar tools, virtual production tools, augmented reality tools, virtual reality tools, and generative media platforms. Policies may be deterministic, model-generated, learned, user-configured, enterprise-configured, rights-owner supplied, platform-supplied, jurisdiction-specific, project-specific, or dynamically updated.

The disclosed methods may be performed locally, remotely, inside a media editing application, inside an operating system, inside a browser extension, inside an AI assistant platform, inside a cloud editing service, or as a gateway between an AI assistant and an editing tool API. The steps may be performed in different orders, repeated, omitted, combined, or distributed across multiple computing devices unless the context requires otherwise.

Many other embodiments are possible.

I claim:

1. A computer-implemented method comprising:
intercepting, by a media agent firewall, an artificial intelligence-generated media editing command before execution by a media editing tool;
generating, from the artificial intelligence-generated media editing command, a command package identifying a command type, a target media asset, a target timeline region, and a requested transformation;
evaluating the command package against one or more media command policies;
generating an enforcement action based on the evaluating; and
controlling execution of the artificial intelligence-generated media editing command by the media editing tool according to the enforcement action.

2. The method of claim 1, wherein the one or more media command policies comprise at least one of a user authorization policy, asset permission policy, likeness policy, voice policy, music licensing policy, brand policy, destructive edit policy, privacy policy, export policy, provenance policy, or platform policy.

3. The method of claim 1, wherein the artificial intelligence-generated media editing command comprises at least one of a trim command, crop command, caption command, audio command, voice synthesis command, face modification command, background replacement command, object insertion command, style transfer command, generative fill command, music insertion command, render command, export command, publish command, delete command, overwrite command, watermark command, or metadata modification command.

4. The method of claim 1, wherein the command package further identifies at least one of a source prompt, assistant output, model identifier, tool identifier, user identifier, session identifier, project identifier, target layer, affected person, affected voice, affected brand element, confidence value, or intended export target.

5. The method of claim 1, wherein generating the enforcement action comprises generating at least one of an allow action, block action, modify action, sandbox action, confirmation request, license request, asset substitution action, watermark action, redaction action, downgrade action, quarantine action, human-review routing action, or log-only action.

6. The method of claim 1, further comprising determining a risk score for the command package based on whether the artificial intelligence-generated media editing command is destructive, modifies protected content, inserts a third-party asset, affects a likeness or voice, changes a legal disclaimer, affects required attribution, exports externally, publishes to a platform, lacks provenance, or violates a branding constraint.

7. The method of claim 1, further comprising identifying affected project assets, timeline regions, project layers, rights records, output destinations, or project states associated with the command package before evaluating the command package against the one or more media command policies.

8. The method of claim 1, wherein controlling execution comprises permitting execution of the artificial intelligence-generated media editing command only after receiving user confirmation or policy clearance.

9. The method of claim 1, further comprising executing the artificial intelligence-generated media editing command in a sandbox project branch before permitting mutation of a primary media project.

10. The method of claim 9, further comprising generating a sandbox preview, evaluating the sandbox preview against at least one of a policy requirement, user intent criterion, rights condition, project constraint, quality threshold, or export requirement, and committing or discarding the sandbox project branch based on the evaluating.

11. The method of claim 1, further comprising determining that the command package requires use of a restricted asset or restricted transformation and modifying the command package to reference a compliant substitute asset or modified transformation.

12. The method of claim 11, wherein the compliant substitute asset or modified transformation is selected from an approved asset repository, licensed media library, enterprise rights database, user-approved media set, policy-compliant generative model output, or platform-approved media source.

13. The method of claim 1, further comprising determining that the command package identifies, modifies, synthesizes, imitates, inserts, transforms, exports, or publishes a protected media element comprising at least one of a person, face, body, gesture, voice, audio asset, music track, image, video asset, brand, logo, product representation, licensed clip, or third-party asset.

14. The method of claim 13, further comprising querying a rights or consent source to determine a clearance status for the protected media element, wherein the rights or consent source comprises at least one of a likeness consent database, voice licensing database, music licensing database, enterprise rights database, brand guideline store, asset repository, user permission store, or platform policy service.

15. The method of claim 14, wherein the clearance status indicates at least one of clearance granted, clearance denied, conditional clearance, expired clearance, unavailable clearance, territorial limitation, platform limitation, duration limitation, attribution requirement, watermark requirement, or escalation requirement.

16. The method of claim 1, further comprising generating an audit log entry identifying at least one of a timestamp, source prompt, assistant output, model identifier, tool identifier, user identifier, session identifier, project identifier, affected asset, affected timeline region, requested transformation, command package, policy evaluation result, or enforcement action.

17. The method of claim 1, further comprising generating a provenance record identifying at least one of source assets, asset fingerprints, source lineage, transformation chain, command modifications, substitute assets, sandbox results, model versions, tool versions, policy references, user approvals, rights clearance status, or export conditions.

18. A system comprising:
one or more processors; and
memory storing instructions that, when executed by the one or more processors, cause the system to implement:
a media agent firewall positioned between an artificial intelligence assistant and a media editing tool;
a command normalizer configured to convert an artificial intelligence-generated media editing command into a command package;
a policy evaluation engine configured to evaluate the command package against one or more media command policies; and
an enforcement controller configured to control execution of the artificial intelligence-generated media editing command by the media editing tool based on an enforcement action generated from the evaluation.

19. The system of claim 18, further comprising at least one of a sandbox controller configured to execute the artificial intelligence-generated media editing command in a sandbox project branch before mutation of a primary media project, a rights and likeness clearance gate configured to determine clearance status for protected media elements, or an audit and provenance recorder configured to store audit and provenance records associated with the artificial intelligence-generated media editing command.

20. A non-transitory computer-readable medium storing instructions that, when executed by one or more processors, cause the one or more processors to:
intercept an artificial intelligence-generated media editing command before execution by a media editing tool;
generate a command package identifying a command type, target media asset, target timeline region, requested transformation, source prompt, model identifier, and parameter values;
evaluate the command package against one or more policies comprising at least one of an authorization policy, asset permission policy, likeness policy, voice policy, music licensing policy, brand policy, destructive edit policy, export policy, or provenance policy;
generate an enforcement action based on the evaluation; control execution of the artificial intelligence-generated media editing command according to the enforcement action; and
store an audit log or provenance record for the artificial intelligence-generated media editing command.
